(19) United States
(12) Patent Application Publication
(10) Pub. No.: US 2015/0095091 A1
(43) Pub. Date: Apr. 2, 2015

(54) Customer-Prioritized Inventory Allocation for Supply Chain

(71) Applicant: Motorola Mobility LLC, Libertyville, IL (US)

(72) Inventor: Gautam H. Kamdar, Singapore (SG)

(73) Assignee: Motorola Mobility LLC, Libertyville, IL (US)

(21) Appl. No.: 14/046,322

(22) Filed: Oct. 4, 2013

Related U.S. Application Data
(60) Provisional application No. 61/883,717, filed on Sep. 27, 2013.

(51) Int. Cl. G06Q 10/06

(52) U.S. Cl. CPC G06Q 10/06315
USPC 705/7.25

(57) ABSTRACT

A method (200) for inventory planning for a supply chain distributing a constrained supply of stock includes determining (204) an anticipated inventory replenishment need for each of a plurality of first nodes at a lowest level tier of the supply chain for which inventory data is available. The method further includes determining (212, 216) an allocation of stock in the supply chain so as to fulfill (220) the anticipated inventory replenishment needs of the plurality of first nodes before allocating any remaining stock to fulfill anticipated inventory needs of nodes at higher level tiers of the supply chain. The method additionally includes distributing stock in the supply chain based on the allocation of stock.

### FIELD OF THE DISCLOSURE

The present disclosure relates generally to supply chain management and more particularly to inventory distribution management.

### BACKGROUND

A fundamental goal of supply chain management is to optimize the allocation of inventory among distribution channels so as to minimize static inventory at any given node in the supply chain. Conventionally, inventory allocation is based on fair-share or forecast modeling for only the proximate downstream tier in the supply chain. Under these approaches, the manufacturer or other supplier allocates inventory to distribution centers based on prioritization of the inventory needs of the distribution center, the distribution centers allocate inventory to lower-level distribution centers or retailers based on prioritization of the inventory needs of the lower-level distribution center or retailers, and so on. However, in a distribution-intensive supply chain or in a supply chain with constrained supply, this next-tier inventory allocation scheme often leads to sub-optimal inventory distribution, with some supply chain nodes at the lowest level of the supply chain (that is, the nodes facing the customers) experiencing a glut of inventory, while others experience inventory shortages. Such slack inventory allocations are costly to the supplier due to opportunity costs, insurance, and obsolescence of the inventory.

### BRIEF DESCRIPTION OF THE DRAWINGS

The present disclosure may be better understood by, and its numerous features and advantages made apparent to, those skilled in the art by referencing the accompanying drawings. The use of the same reference symbols in different drawings indicates similar or identical items.

FIG. 1 is a diagram illustrating a supply chain implementing an inventory planning system for allocating distribution of stock based on a customer-prioritized channel allocation scheme in accordance with at least one embodiment of the present disclosure.

FIG. 2 is a flow diagram illustrating a method for customer-prioritized channel inventory allocation in accordance with at least one embodiment of the present disclosure.

FIG. 3 is a chart illustrating an example application of the method of FIG. 2 to the example supply chain of FIG. 1 in accordance with at least one embodiment of the present disclosure.

FIG. 4 is a diagram illustrating an example implementation of a computing system of an inventory planning system in accordance with at least one embodiment of the present disclosure.

### DETAILED DESCRIPTION

The following description is intended to convey a thorough understanding of the present disclosure by providing a number of specific embodiments and details involving inventory management for distribution channels of a supply chain. It is understood, however, that the present disclosure is not limited to these specific embodiments and details, which are examples only, and the scope of the disclosure is accordingly intended to be limited only by the following claims and equivalents thereof. It is further understood that one possessing ordinary skill in the art, in light of known systems and methods, would appreciate the use of the disclosure for its intended purposes and benefits in any number of alternative embodiments, depending upon specific design and other needs.

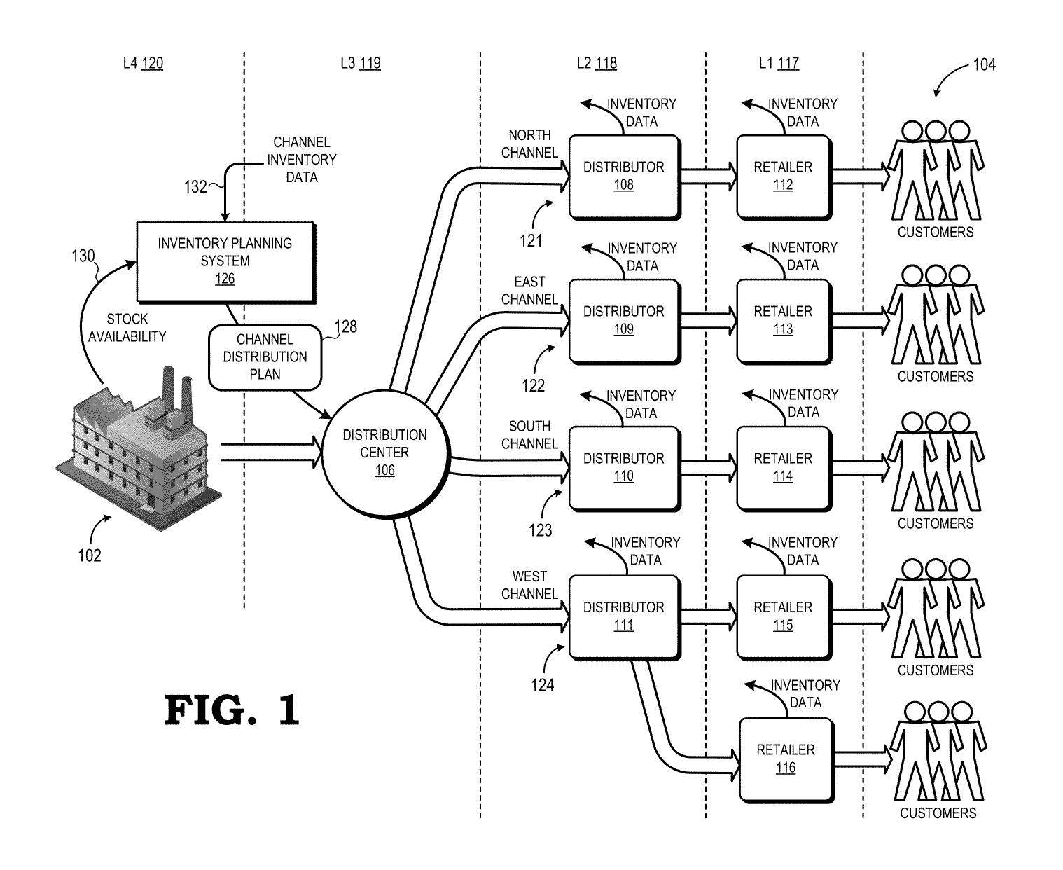

FIGS. 1-4 illustrate example techniques for inventory allocation management in a supply chain. In at least one embodiment, an inventory management system of a supply chain implements an inventory allocation plan that prioritizes fulfillment of the anticipated inventory replenishment needs of the supply nodes directly servicing the customer, or in the event that inventory data for the customer-facing supply nodes is not available, the lowest tier of supply nodes for which inventory data is available. Under this approach, a given supply of stock at a supplier is allocated so as to fulfill the inventory replenishment needs of the supply nodes at the lowest tier of the supply chain. In the event that the stock supply is not sufficient to at least fully cover the lowest tier's inventory replenishment needs, the stock supply is allocated among the supply nodes of the lowest tier using, for example, a fair-share or proportional allocation scheme. In the event that the stock supply exceeds the anticipated inventory replenishment needs of the lowest tier, remaining unallocated stock is allocated among the supply nodes of the next-lowest tier based on their anticipated inventory replenishment needs.

This allocation process can be iterated at each successively-higher supply chain tier until the entire supply of stock has been allocated. The resulting channel allocation plan is then implemented by distributing to each channel in the supply chain a corresponding total quantity of units of stock representing the sum of the stock allocation for each node within the channel. The stock allocated to each channel is then sequentially distributed tier-by-tier through the channel, with each node in the channel retaining its allocation of stock and forwarding the remaining received stock to the next node in the channel. Under this approach, improved inventory management at the customer-facing nodes with improved customer service levels can be achieved without resulting in the excess inventory investment that normally accompanies customer-optimized inventory allocation schemes.

For ease of illustration, inventory allocation techniques are described below in an example context of a three-tier supply chain for the distribution of electronic consumer goods, with the manufacturing facility acting as the stock supplier at the highest tier, distribution centers serving as the intermediate supply nodes at a middle tier, and retailers selling the electronic consumer goods serving as the supply nodes at the lowest tier, or customer-facing tier, of the supply chain. These inventory allocation techniques are not limited to this context, but instead may be used for the distribution of any of a variety of goods, and also may be implemented in supply chains having more than three tiers. Further, it is assumed for explanatory purposes that the supply chain is able to obtain inventory data for the supply nodes at the customer-facing tier. However, in some implementations, this inventory data may not be available for one or more customer-facing supply nodes, and thus the techniques described herein may be applied as though the lowest tier of supply nodes for which such inventory data is available is the customer-facing tier. Accordingly, reference to the customer-facing tier and customer-facing supply nodes applies equally to such lowest-inventory-data-available tier or supply nodes unless otherwise noted.

FIG. 1 illustrates a supply chain 100 implementing a lowest-tier-prioritizing channel allocation scheme in accordance with at least one embodiment of the present disclosure. For the following examples, the supply chain 100 is used to distribute electronic consumer goods (e.g., mobile consumer devices such as cellular phones) from a supplier 102 (e.g., a manufacturing plant) to customers 104 via a network of supply chain nodes, which include a distribution center 106, a plurality of distributors 108, 109, 110, and 111 (collectively, “distributors 108-111”), and a plurality of retailers 112, 113, 114, 115, and 116 (collectively, “retailers 112-116”). In this configuration, the retailers 112-116 constitute the supply chain nodes of a first, or lowest-level, tier 117 (also denoted as the “L1 tier”) facing the customers 104, the distributors 108-111 constitute the supply chain nodes of a second, or next-lowest-level, tier 118 (also denoted as the “L2 tier”), the distribution center 106 constitutes the supply chain node of a third-level tier 119 (also denoted as the “L3 tier”), and the supplier 102 constitutes a fourth-level tier 120 (also denoted as the “L4 tier”). The distributors 108-111 and the retailers 112-116 are arranged, with respect to the distribution center 106, as a plurality of distribution channels, with each distribution channel including one distributor and one or more retailers stocked via the distributor. In the illustrated example, these distribution channels include a distribution channel 121 including the distributor 108 and the retailer 112 (the “North channel”), a distribution channel 122 including the distributor 109 and the retailer 113) (the “East channel”), a distribution channel 123 including the distributor 110 and the retailer 114 (the “South channel”), and a distribution channel 124 including the distributor 111 and the retailers 115 and 116 (the “West channel”).

As is typical in channel-based supply chains, the supply chain 100 is arranged in a hub-and-spoke arrangement whereby each node has a single upstream source node, but may have one or more downstream recipient nodes. To illustrate, the distribution center 106 distributes stock to distributors 108-111, but each of distributors 108-111 look only to distribution center 106 for supply of the stock distributed by the supply chain 100. Likewise, each of retailers 112-116 seeks stock from only one of distributors 108-111, but each distributor may supply stock to more than one retailer (e.g., distributor 111 supplies stock to retailers 115 and 116 in the example shown in FIG. 1). This hub-and-spoke configuration typically is maintained due to transaction costs, such as taxation issues, geographical or political borders, inspection station locations, transportation logistics, delivery timing, sales inventive plans, and the manner in which each node reports its inventory data upstream. As such, the affiliation of nodes within a channel may be a result of geographical influences, political boundaries, taxation regimes, and the like.

Generally, the supplier 102, the distribution center 106, the distributors 108-111, and the retailers 112-116 are under the control of a common entity or are coordinated entities working together through contractual or other business arrangements. To illustrate, in an example whereby the supply chain 100 is implemented to distribute mobile consumer electronic devices for a consumer electronic goods company, the supplier 102 and the distribution center 106 may be controlled by the consumer electronic goods company or its subsidiaries, whereas the retailers 112-116 and distributors 108-111 may, for example, constitute separate cellular phone distributors and stores associated with a particular cellular carrier and which carry mobile consumer electronic devices.

The supply chain 100 operates to distribute stock (e.g., consumer electronic goods) produced by the supplier 102 to the retailers 112-116, whereupon the stock may then be sold or otherwise transferred to the customers 104. To this end, an inventory planning system 126 receives various supply chain inputs to determine, based on an inventory management plan, a channel distribution plan 128 that specifies how a given supply of stock from the supplier 102 is to be distributed by the supply chain 100. The supply chain 100 then implements the channel distribution plan 128 to distribute the supply of stock from the distribution center 106 to the channels 121-124. In turn, the subset of the stock supply provided to a corresponding channel is then distributed among the nodes in the channel according to the channel distribution plan 128. The distribution of stock from the node at one tier to the next tier may be achieved, for example, via air transport, ground transport, waterway transport, private courier, postal carrier, and combinations thereof.

In some embodiments, the channel distribution plan 128 specifies the allocation of the supply of stock on a channel-by-channel basis, as well as a node-by-node basis within each given channel. To illustrate using a simple example, given a stock supply of 1,000 units, the resulting channel distribution plan 128 may be represented by Table 1 below, in which the North channel 121 is allocated a total quantity of 300 units, the East channel 122 is allocated a total quantity of 175 units, the South channel 123 is allocated a total quantity of 225 units, and the West channel 124 is allocated 400 units. Of the 300 units allocated to the North channel 121, 100 units are allocated to replenish inventory at the distributor 108 and 200 units are allocated to replenish inventory at the retailer 112. Of the 175 units allocated to the East channel 122, 75 units are allocated to replenish inventory at the distributor 109 and 100 units are allocated to replenish inventory at the retailer 113. Of the 225 units allocated to the south channel 123, 50 units are allocated to replenish inventory at the distributor 110, and 175 units are allocated to the retailer 114. Finally, of the 400 units allocated to the West channel 124, 175 units are allocated to replenish inventory at the distributor 111, 125 units are allocated to replenish inventory at the retailer 115, and 100 units are allocated to replenish inventory at the retailer 116.

TABLE 1
Example Channel Distribution Plan 128 for 1,000 Units:

| CHANNEL | | STOCK |
|---|---|---|
| NORTH | | 300 |
| | DISTRIBUTOR 108 | 100 |
| | RETAILER 112 | 200 |
| EAST | | 175 |
| | DISTRIBUTOR 109 | 75 |
| | RETAILER 113 | 100 |
| SOUTH | | 225 |
| | DISTRIBUTOR 110 | 50 |
| | RETAILER 114 | 175 |
| WEST | | 400 |
| | DISTRIBUTOR 111 | 175 |
| | RETAILER 115 | 125 |
| | RETAILER 116 | 100 |

Thus, to implement this example channel distribution plan 128 in this example, after receiving the 1,000 unit stock supply, the distribution center 106 would ship 300 units to the distributor 108, ship 175 units to the distributor 109, ship 225 units to the distributor 110, and ship 400 units to the distributor 111. After receiving the 300 units, the distributor 108 would then ship 200 units to the retailer 112 while retaining the remaining 100 units to replenish its inventory. Likewise, after receiving its 175 unit allocation, the distributor 109 would then ship 75 units to the retailer 113 while retaining the remaining 100 units to replenish its inventory. After receiving its 225 unit allocation, the distributor 110 would then ship 175 units to the retailer 114 while retaining the remaining 50 units for inventory replenishment needs. Similarly, after receiving its 400 unit allocation, the distributor 111 would then ship 125 units to the retailer 115, ship 100 units to the retailer 116, and retain the remaining 175 units to replenish its inventory.

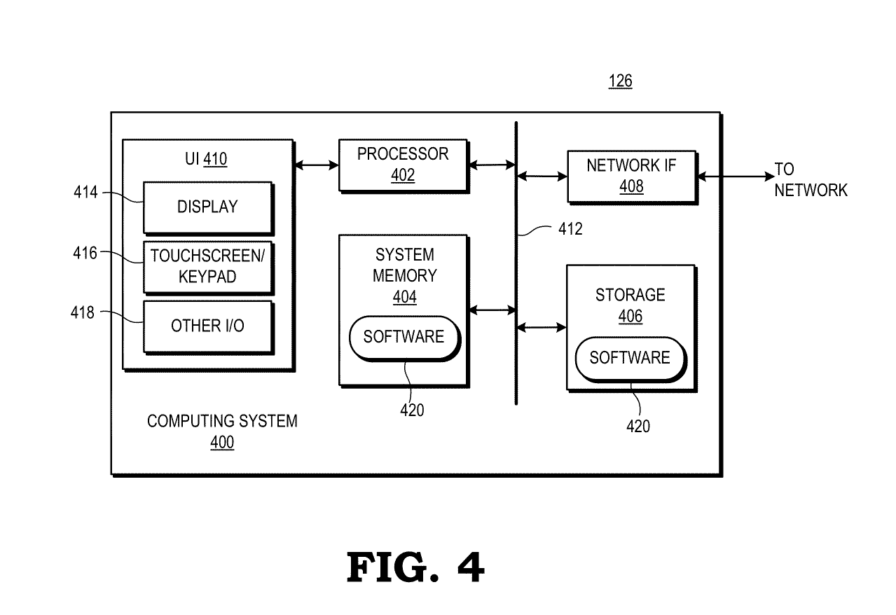

In at least one embodiment, the inventory planning system 126 is implemented as a computing platform utilizing one or more computing resources and corresponding software applications. This computing platform may be centralized at, for example, the supplier 102 or the distribution center 106, or may be distributed among one or more nodes of the supply chain. To illustrate, the inventory planning system 126 may implement computing systems at the distributors 108-111 (e.g., as warehouse tracking applications) and the retailers 112-116 (e.g., as point-of-sale or inventory stock-keeping unit (SKU) tracking systems) to determine and transmit upstream the inventory data at each of these nodes, and implement a computing system at the distribution center 106 to receive this inventory data from the downstream nodes and calculate or otherwise determine the channel distribution plan 128 based on this inventory data and other inputs. Data representing these inputs and other inventory information may be communicated among the distributed computing platforms using, for example, an electronic data interchange (EDI) format implementing message transactions conforming to the Uniform Communication Standards (UCS) or the American National Standards Institute (ANSI) Accredited Standards Committee X12M manufacturing communications standards. An example of such is the X12.852 standard that specifies message format standards used by retailers to transmit point of sale data, such as units sold and units on hand, to suppliers via EDI. An example computer system implementing at least a portion of the inventory planning system 126 is described in greater detail below with reference to FIG. 4.

Consistent with a computer-based implementation for the inventory planning system 126, in some embodiments, the channel distribution plan 128 is implemented in an electronic format, such as an electronic spreadsheet file or comma-separated value (CSV) file, one or more database entries or objects, or a set of EDI messages, and propagated through the supply chain 100 in this form. In other embodiments, the channel distribution plan 128 may be propagated through the supply chain 100 through written or printed communications, verbal communications, or a combination of electronic, written, and verbal communications.

As noted above, the inventory planning system 126 generates the channel distribution plan 128 for a given supply of stock based on various inputs from the supply chain 100. These inputs include, for example, current stock or inventory information, such as stock availability data 130 representing the quantity of units of stock available from the supplier 102 for distribution (that is, the stock supply) and inventory data from each of the supply chain nodes that represents the current inventory at the corresponding node (collectively referred to as “channel inventory data 132”). The inputs to the inventory planning system 126 may also include prospective stock supplies (and timing) and prospective inventory planning inputs (and timing), such as target inventory metrics that specify, for example, either a target quantity of units in inventory at each node (on either a node-by-node basis or tier-by-tier basis) or a target number of days of inventory at each node based on past, current, or predicted stock sales rates or other stock depletion rates (likewise on either a node-by-node basis or tier-by-tier basis).

These inputs are stored in a database or other data store of the inventory planning system 126 as they are received. Based on these inputs, the inventory planning system 126 generates the channel distribution plan for distributing a specified stock supply to the lower level tiers of the supply chain 100. In conventional implementations with a supply-constrained or distribution-intensive supply chain, a distribution plan is developed based on the forecast needs, orders, or service level requirements of the next-lower tier in the supply chain. However, this can lead to less than optimal allocation of stock within the supply chain, as noted above. To provide a more optimal stock allocation, rather than consider only the next-lowest tier in inventory management, the inventory planning system 126 instead places priority or emphasis on the inventory replenishment need of the nodes of the lowest-level tier in the supply chain 100. Under this approach, the inventory planning system 126 develops the channel distribution plan 128 so as to attempt to fully replenish the inventory of the stock at the customer-facing nodes (that is, the retailers 112-116) at the L1 tier. Should the stock supply exceed the stock needed to replenish the retailers 112-116, the inventory planning system 126 configures the channel distribution plan 128 so as to then allocate the remaining stock to attempt to fully replenish the inventory of the stock at the nodes (that is, the distributors 108-111) at the second-lowest-level tier (tier L2), and so forth. Under this approach, the constrained supply of stock is distributed to manage the service level at the customer-facing nodes while avoiding excess inventory at nodes at higher-level tiers.

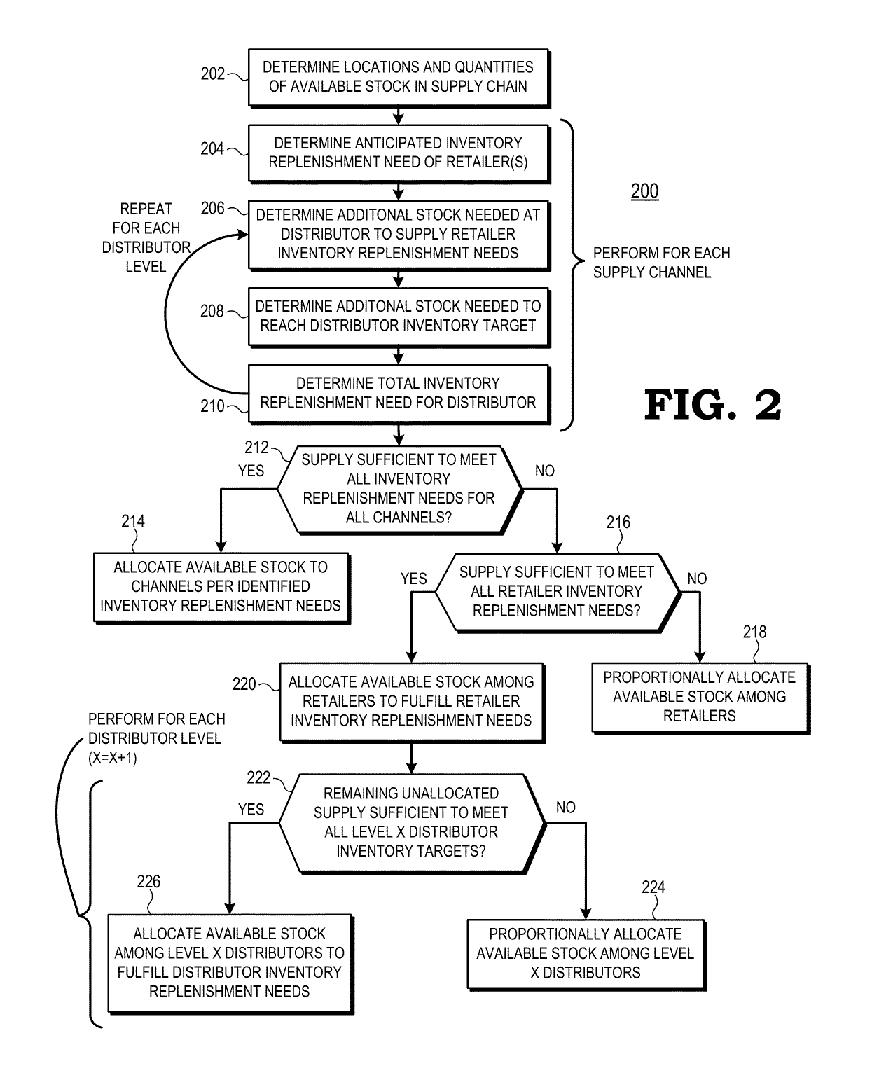

FIG. 2 illustrates an example method 200 implemented by the inventory planning system 126 of the supply chain 100 of FIG. 1 to develop a customer-prioritized channel distribution plan 128 in accordance with at least one embodiment of the present disclosure. As an initial matter, in order to determine where to allocate stock from the specified stock supply, the inventory planning system 126 needs to understand the current inventory state of the nodes of the supply chain 100. Accordingly, the method 200 initiates at block 202, whereby the inventory planning system 126 determines the location and quantities of stock currently available in the supply chain 100. This can include, for example, receiving the stock availability data 130 from the supplier 102 indicating the quantity of stock to be allocated in the supply chain (i.e., the stock supply), and the channel inventory data 132 that represents the available inventory at each node in the supply chain 100 (or at least each node that has the ability to communicate such information). In some embodiments, this data is communicated to the inventory planning system 126 using EDI messages or other messages from the computing systems at each of the nodes, such as from warehouse tracking systems at the distributors 108-111 and from point-of-sale terminals or store inventory tracking systems at the retailers 112-116.

Further, in some embodiments, the inventory planning system 126 may determine certain inventory data, such as current inventory or estimated sales rate, of a retailer based on information received independent of the retailer. The estimated sales rate could be an average or weighted average of a historical sales rate, could be a forecast based on lifecycle information, or could be a blend of both historical and lifecycle approaches. To illustrate, the distributed stock may include cellular phones or other mobile consumer devices that require the user to register or otherwise activate the mobile consumer device with the supplier before they can be used. This registration process typically involves submission of a unique identifier of the mobile consumer device (e.g., an electronic serial number (ESN) or international mobile equipment identity (IMEI) number) to the supplier. As the supplier typically tracks which mobile consumer devices are supplied to a given retailer based on these unique identifiers, the registration of a mobile consumer device using its unique identifier allows the supplier to identify the retailer that sold the mobile consumer device. Cumulatively, this information allows the supplier to track the current inventory of the retailer as well as the estimated sales rate of the mobile consumer device at the retailer.

At block 204, the inventory planning system 126 determines the anticipated inventory replenishment need for the retailer; that is, the additional stock needed to be delivered to the retailer in order for the retailer to reach a target inventory, and which is calculated as the difference between the current stock on hand at the retailer and the total stock representing the target inventory for the retailer. This target inventory can be expressed as, for example, a target number of days of inventory at a forecast inventory sales rate for the retailer. Thus, assuming, for example, a target number days of inventory of 7 days and a sales rate of 100 units per day, the target inventory for the retailer would be 700 units (7 days*100 units/day). Assuming this target inventory of 700 units at the retailer, if the retailer has only 264 units on hand, then the anticipated inventory replenishment need for the retailer is 436 units (700-264 units). The calculation of the anticipated inventory replenishment need for a retailer thus may be represented by the expressions:

TI_{—}R=Tgt_Days*Sales_Rate

IRN_{—}R=TI_{—}R−CurrInv_{—}R

where TI_R represents the target inventory for the retailer, Tgt_Days represents the target number of days of inventory, Sales_Rate represents the estimated sales rate of stock per day, IRN_R represents the anticipated inventory replenishment need for the retailer, and CurrInv_R represents the current quantity of units in inventory at the retailer.

At block 206, the inventory planning system 126 determines the additional stock needed at the lowest-level distributor (the penultimate level tier, in this example) in order to be able to supply stock to meet the target inventories of the one or more retailers (the ultimate level tier, in this example) of the channel supplied by the lowest-level distributor. To illustrate the example described above, if lowest-level distributor tier has a current inventory of 160 units, and the retailer served by this lowest-level distributor has the anticipated inventory replenishment need of 436 units, then the lowest-level distributor will need 276 additional units of stock to fulfill the anticipated inventory replenishment need of the retailer. Generally, the distributors in a supply chain often have inventory targets of their own, so at block 208 the inventory planning system 126 determines the additional stock needed at the lowest-level distributor to fulfill target inventory for the lowest-level distributor. To illustrate, if the current forecast or anticipated order rate is 7000 units per week (seven days), and the target inventory for the distributor is 6 days of inventory, then the distributor will need 6000 units (6 days*7000 units/7 days) in stock to reach this target inventory.

From the additional stock needed at the distributor to fulfill the retailer anticipated inventory replenishment needs and from the stock needed at the distributor to reach the distributor target inventory, at block 210 the inventory planning system 126 determines the total anticipated inventory replenishment need for the lowest-level distributor. The calculation of the total anticipated inventory replenishment need may be represented by the expression:

$$IRN\_D = {\sum }_{i = 1}^{n} IRN\_R ( i ) + TI\_D - CurrInv\_D$$

where IRN_D represents the total anticipated inventory replenishment need for the distributor, n represents the number of retailers supplied by the distributor, IRN_R(i) represents the anticipated inventory replenishment need for the ith retailer, TI_D represents the target inventory for the distributor, and CurrInv_D represents the current number of units in inventory at the distributor.

In the example supply chain 100, there is only one tier of distributors. However, in other implementations, there may be multiple tiers of distributors. In such instances, the process represented by blocks 206-210 may be repeated for each successively-higher-level distributor in the selected channel, but with each calculation referencing the next-lower-level distributor, rather than the retailer (that is, blocks 206-210 repeated with the next-lower-level distributor substituted for the retailer).

After calculating the anticipated inventory replenishment needs for each node at each tier in the selected channel, the inventory planning system 126 selects the next channel and repeats the process of blocks 204-210 for the next selected channel, and continues to do so until all channels have been assessed. With all channels so assessed, at block 212 the inventory planning system 126 sums the anticipated inventory replenishment needs for each node in each channel to determine a total inventory replenishment need for the supply chain 100, and then compares this value to the number of units in the stock supply to determine whether the stock supply is sufficient to meet the inventory replenishment needs of all nodes in the supply chain 100. If the number of units in the stock supply is equal to or exceeds the total inventory replenishment need, the supply of stock is not constrained, and thus at block 214, the inventory planning system 126 configures the channel distribution plan 128 so as to distribute to each node a quantity of stock at least equal to the anticipated inventory replenishment need calculated for that node.

Returning to block 212, if the inventory planning system 126 determines that the supply is constrained, that is, the stock supply is insufficient to fulfill the inventory replenishment needs of all nodes, the inventory planning system 126 then implements a distribution plan that priorities supply of stock to the retailers 112-116 as they are closest to the customers. Accordingly, at block 216, the inventory planning system 126 determines whether the stock supply is sufficient to meet the anticipated inventory replenishment needs of all retailers in the supply chain 100. That is, the inventory planning system 126 determines whether at least the all of the retailers' inventories can be fully replenished. If not, at block 218, the inventory planning system 126 allocates the entire stock supply among the retailers 112-116 and configures the channel distribution plan 128 accordingly. This allocation can include, for example, a proportional allocation, whereby each retailer gets a share of the stock supply proportional to its anticipated inventory replenishment need after taking into account inventory available from higher-level tiers supplying that retailer. Alternatively, the allocation can include a fair-share allocation, whereby each retailer gets a same quantity of the limited stock supply.

Returning to block 216, if there is sufficient stock to at least fulfill the inventory replenishment needs of the retailers 112-116, at block 220 the inventory planning system 126 allocates to each retailer a quantity of stock equal to its anticipated inventory replenishment need and configures the channel distribution plan 128 accordingly. At block 222, the inventory planning system 126 determines whether there is unallocated stock from the stock supply, and if so, whether the remaining unallocated stock is sufficient to fulfill the inventory target needs of all of distributors 108-111. If not, at block 224 the inventory planning system 126 allocates the remaining unallocated stock among the distributors 108-111 according to, for example, a fair-share or proportional allocation, and configures the channel distribution plan 128 accordingly. Otherwise, if the remaining unallocated stock is sufficient, at block 226 the inventory planning system 126 allocates to each distributor a quantity of unallocated stock equal to its inventory target need and configures the channel distribution plan 128 accordingly.

As the example supply chain 100 includes only a single tier of distributors, at this point the channel distribution plan 128 would be ready for implementation in the supply chain 100. However, in other implementations, the supply chain 100 could have multiple tiers of distributors. In such instances, if there is additional unallocated stock available after the allocation of stock to fulfill target inventory needs of the lowest-level distributors at block 226, the process of blocks 222, 224, and 226 can be repeated for the next level of distributors to allocate unallocated stock to the second-lowest-level distributors, and so forth, until all units of the stock supply have been allocated.

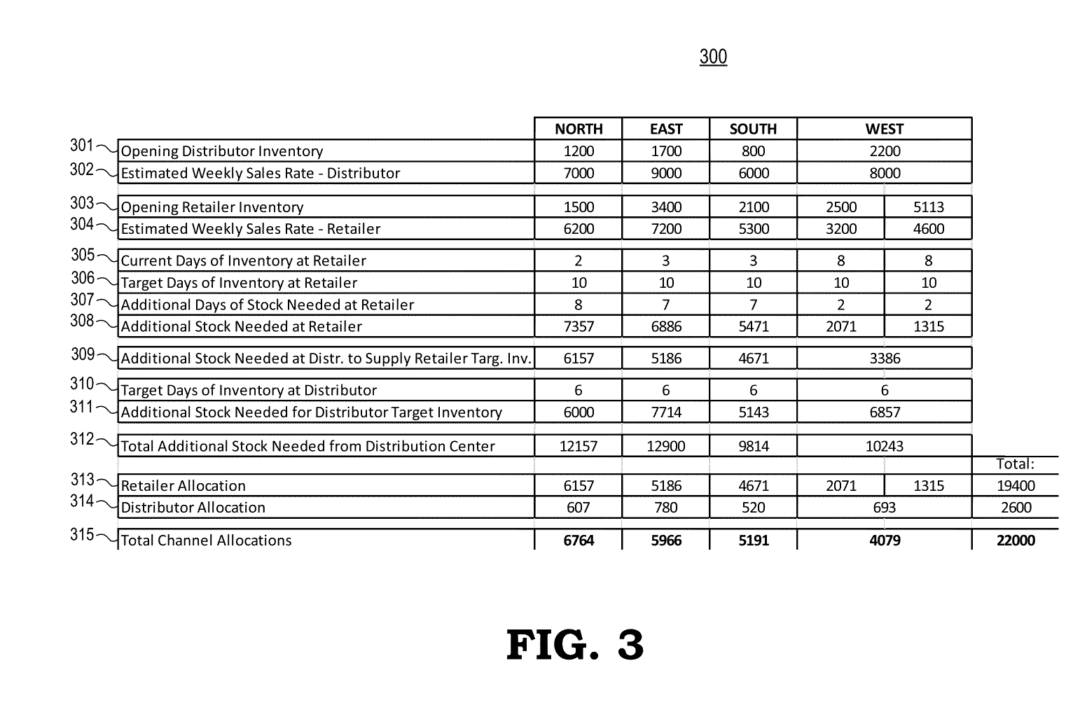

FIG. 3 illustrates a table 300 depicting an example implementation of the method 200 for determining the depicted example of the channel distribution plan 128 in accordance with at least one embodiment of the present disclosure. For the following, it is assumed that the stock supply available for allocation is 22,000 units of stock. Prior to allocating the stock supply, the inventory planning system 126 determines the quantity and location of stock already distributed in the supply chain 100. As illustrated by rows 301 and 303, in this example, the inventory planning system 126 determines that: in the North channel 121, the distributor 108 currently has 1200 units of stock and the retailer 112 currently has 1500 units of stock; in the East channel 122, the distributor 109 currently has 1700 units of stock and the retailer 113 currently has 3400 units of stock; in the South channel 123, the distributor 110 currently has 800 units of stock and the retailer 114 currently has 2100 units of stock; and in the West channel 124, the distributor 110 currently has 2200 units of stock, the retailer 115 currently has 2500 units of stock, and the retailer 116 currently has 1315 units of stock.

From these available stock numbers and the estimated weekly sales rate of the retailers, the inventory planning system 126 determines the corresponding current number of days of inventory at each retailer (row 305). With the target number of days of inventory at the retailers (row 306), the estimated weekly sales rate of the retailers (row 304), and the current inventories of the retailers (row 303), the inventory planning system 126 determines the additional quantity of stock needed at each retailer, that is, the anticipated inventory replenishment needs of the retailers (row 308), which also may be represented in terms of additional days of inventory needed at the retailer (row 307). The estimated weekly sales rate for a retailer can be a running average of the past few weeks or a more sophisticated estimate based on other variables such as product lifecycle, seasonal adjustments, local environmental factors such as weather and competitive store openings or closings, advertising, and pricing.

By subtracting the current inventory at each distributor (row 301) from the anticipated inventory replenishment needs of the retailers served by the distributor (row 308), the inventory planning system 126 determines the additional stock needed at each distributor to fulfill the anticipated inventory replenishment needs of the corresponding retailers (row 309). Further, with the target number of days of inventory for the distributors (row 310) and the estimated weekly sales rate of the distributors (row 302), the inventory planning system 126 can calculate the additional stock needed to reach the target inventory for each distributor (row 311). The estimated weekly sales rate for a distributor can be a running average of the past few weeks or a more sophisticated estimate based on other variables such as product lifecycle, seasonal adjustments, regional environmental factors such as weather, advertising, and pricing.

To determine the allocation needs of each channel, the inventory planning system 126 sums the values in row 309 (that is, the additional stock needed at the distributor of the channel to fulfill the anticipated inventory replenishment needs of the corresponding retailers) with the values in row 311 (that is, the additional stock needed at the distributor of the channel to meet its target inventory) to arrive at the total additional stock needed from the distribution center 106 to fulfill all of the inventory replenishment needs of the corresponding channel (row 312). As illustrated by Table 3, the North channel 121 needs 12,157 units of stock to fully replenish its node's inventories, the East channel 122 needs 12,900 units to fully replenish its node's inventories, the South channel 123 needs 9,814 units of stock to fully replenish its node's inventories, and the West channel 124 needs 10,243 units of stock to fully replenish its node's inventories. Thus, the total stock allocation needed to fully replenish the inventories of the supply chain 100 is 45,114 units of stock, which far exceeds the stock supply of 22,000 units in this example.

As the stock supply is thus constrained, the inventory planning system 126 selectively allocates the limited stock supply using the customer-prioritizing allocation scheme described above. Accordingly, because the sum total of the anticipated inventory replenishment needs of the retailers, 19,400 units (sum of quantities of row 309), is less than the stock supply of 22,000 units, the inventory planning system 126 can allocate stock to each of the retailers so as to fulfill each retailer's anticipated inventory replenishment needs (row 313). However, because the remaining 2600 units of unallocated stock is insufficient to completely fulfill each distributor's additional stock needs to meet the distributor's target inventories, the inventory planning system 126 instead allocates the remaining unallocated stock among the distributors (row 314) proportional to the stock needed in inventory at the distributor to reach the target inventory for the distributor (row 311). Thus, rows 313 and 314 represent the channel distribution plan 128 for the allocation of available stock to the retailers and the distributors, respectively, in this example. Row 315 represents the sum of the retailer allocation and the distributor allocation for each channel, and thus represents the total stock allocation for each channel in accordance with this channel distribution plan. Note that if excess inventory is available at higher-level tiers in any single channel (e.g., if row 301 is greater than row 308 plus row 311 in any single column), available stock does not need to be allocated to that distributor. In this manner, scarcity of available stock is borne by higher-level tiers before affecting the lowest-level tiers.

FIG. 4 illustrates an example implementation of the inventory planning system 126 of the supply chain 100 of FIG. 1 in accordance with at least one embodiment of the present disclosure. In the depicted example, the inventory planning system 126 is implemented as one or more computing systems 400, each computing system 400 including a processor 402 (e.g., a central processing device or CPU), one or more non-transitory computer readable storage media, such as system memory 404 or another storage device 406 (e.g., flash memory, optical or magnetic disc drive, solid state hard drive, etc.), a network interface 408 (e.g., a wireless local area network (WAN) interface or wired Ethernet interface), and a user interface (UI) 410 all connected via one or more busses 412 or other interconnects. The UI 410 includes, for example, a display device 414 and a keypad or touch panel 416, as well as other input/output components 418 to receive input from, or provide information to, a user.

The processor 402 executes a set of executable instructions stored at a computer readable storage medium, such as the system memory 404 or flash memory, whereby the set of executable instructions represent one or more software programs 420. The software applications 420, when executed, manipulate the processor 402 to perform various software-based functionality to implement at least a portion of the techniques described above, provide visual information via the display device 414, respond to user input via the touch panel 416, and the like. Thus, much of the inventive functionality and many of the inventive principles described above are well suited for implementation with or in software programs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs minimal experimentation. Therefore, in the interest of brevity and minimization of any risk of obscuring the principles and concepts according to the present disclosure, further discussion of such software, if any, will be limited to the essentials with respect to the principles and concepts within the preferred embodiments.

In this document, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

The specification and drawings should be considered as examples only, and the scope of the disclosure is accordingly intended to be limited only by the following claims and equivalents thereof. Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. The steps of the flowcharts depicted above can be in any order unless specified otherwise, and steps may be eliminated, repeated, and/or added, depending on the implementation. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method for inventory planning for a supply chain distributing a constrained supply of stock, the method comprising:
determining an anticipated inventory replenishment need for each of a plurality of first nodes at a lowest level tier of the supply chain for which inventory data is available;
determining an allocation of stock in the supply chain so as to fulfill the anticipated inventory replenishment needs of the plurality of first nodes before allocating any remaining stock to fulfill anticipated inventory replenishment needs of nodes at higher level tiers of the supply chain; and
distributing stock in the supply chain based on the allocation of stock.

2. The method of claim 1, wherein:
the lowest level tier of the supply chain for which inventory data is available comprises retailers of the stock.

3. The method of claim 1, wherein determining the anticipated inventory replenishment need for each of the plurality of first nodes comprises:
for each first node of the plurality of first nodes:
determining an available inventory of the stock at the first node;
determining an estimated sales rate of the stock at the first node; and
determining the anticipated inventory replenishment need for the first node based on the available inventory, the estimated sales rate, and a target inventory for the first node.

4. The method of claim 3, wherein:
the stock includes mobile consumer devices; and
determining the estimated sales rate of the stock at the first node comprises determining an average rate of user registration of mobile consumer devices distributed to the first node.

5. The method of claim 1, wherein determining the allocation of stock in the supply chain comprises:
for each of a plurality of second nodes at a second-lowest level tier of the supply chain:
determining an available inventory of the stock at the second node; and
determining an allocation of stock to the second node based on a difference between the anticipated inventory replenishment need of a first node serviced by the second node and the available inventory of the stock at the second node.

6. The method of claim 5, wherein determining the allocation of stock in the supply chain further comprises:
determining an anticipated inventory replenishment need for each second node of the plurality of second nodes; and
in response to stock being available for allocation after allocation of stock in the supply chain so as to fulfill the anticipated inventory replenishment needs of each of the plurality of first nodes, determining an allocation of the available stock to the second nodes so as to at least partially fulfill the anticipated inventory replenishment needs of the second nodes.

7. The method of claim 6, wherein determining the allocation of stock in the supply chain further comprises:
determining an anticipated inventory replenishment need for each of a plurality of third nodes at a third-lowest level tier of the supply chain; and
in response to stock being available for allocation after allocation of stock in the supply chain so as to at least partially fulfill the anticipated inventory replenishment needs of the second nodes, determining an allocation of the available stock to the third nodes based on the anticipated inventory replenishment needs of the third nodes.

8. The method of claim 1, wherein determining the allocation of stock in the supply chain comprises:
in response to a sum of the anticipated inventory replenishment needs exceeding an available supply of stock, determining an allocation of the stock proportional to the anticipated inventory replenishment need of each first node.

9. The method of claim 1, wherein:
the stock is units of a consumer product; and
the first nodes are retailers of the consumer product.

10. A method for allocating a constrained supply of a consumer product in a supply chain, the method comprising:
storing, at an inventory planning system, retailer inventory data indicating an available inventory of the consumer product at each of a plurality of retailers in the supply chain;
storing, at the inventory planning system, distributor inventory data indicating an available inventory of the consumer product at each of a plurality of distributors in the supply chain, each distributor sourcing the consumer product for a corresponding retailer;
determining, at the inventory planning system, retailer inventory replenishment needs based on the retailer inventory data and the distributor inventory data, each retailer inventory replenishment need indicating additional stock of the consumer product needed at a corresponding distributor to meet a target inventory supply for the corresponding retailer; and
determining, at the inventory planning system, an allocation of the consumer product among the distributors to prioritize fulfillment of the retailer inventory replenishment needs.

11. The method of claim 10, further comprising:
distributing units of the consumer product in the supply chain based on the allocation of the consumer product.

12. The method of claim 10, wherein determining retailer inventory replenishment needs based on the retailer inventory data and the distributor inventory data comprises:
determining a target inventory of the consumer product for a retailer; and
determining the retailer inventory replenishment need for the retailer as the target inventory less the available inventory of the consumer product at the retailer.

13. The method of claim 10, wherein determining the allocation of the consumer product among the distributors to prioritize fulfillment of the retailer inventory replenishment needs comprises:
determining a first allocation of the consumer product to the distributors to fulfill the retailer inventory replenishment needs for the retailers; and
in response to the first allocation being less than a total supply of the consumer product available for distribution in the supply chain:
determining distributor inventory replenishment needs based on the distributor inventory data, each distributor inventory replenishment need indicating an additional stock of the consumer product needed at a corresponding distributor to meet a target inventory supply for the corresponding distributor; and
determining a second allocation of consumer product available after the first allocation based on the distributor inventory replenishment needs.

14. The method of claim 13, wherein the target inventory of the consumer product for the retailer comprises a target number of days of consumer product available at the retailer based on an estimated sales rate of the consumer product at the retailer.

15. The method of claim 14, wherein determining the allocation of the consumer product among the distributors to prioritize fulfillment of the retailer inventory replenishment needs comprises:
in response to a sum of the retailer inventory replenishment needs exceeding an available supply of the consumer product, determining an allocation of the available supply of the consumer product that is proportional to at least one of the retailer inventory replenishment need of each retailer and the estimated sales rate of the stock at each retailer.

16. An inventory planning system for allocating distribution of a supply of a consumer product in a supply chain, the inventory planning system comprising:
a computer-readable storage medium to store a set of executable instructions; and
at least one processor to execute the set of executable instructions, wherein the set of executable instructions include executable instructions to manipulate the at least one processor to:
store retailer inventory data indicating an available inventory of the consumer product at each of a plurality of retailers in the supply chain;
store distributor inventory data indicating an available inventory of the consumer product at each of a plurality of distributors in the supply chain, each distributor sourcing the consumer product for a corresponding retailer;
determine retailer inventory replenishment needs based on the retailer inventory data and the distributor inventory data, each retailer inventory replenishment need indicating additional stock of the consumer product needed at a corresponding distributor to meet a target inventory supply for the corresponding retailer; and
determine an allocation of the consumer product among the distributors to prioritize fulfillment of the retailer inventory replenishment needs.

17. The inventory planning system of claim 16, wherein the executable instructions to manipulate the at least one processor to determine retailer inventory replenishment needs based on the retailer inventory data and the distributor inventory data include executable instructions to manipulate the at least one processor to:
determine a target inventory of the consumer product for a retailer; and
determine the retailer inventory replenishment need for the retailer as the target inventory less the available inventory of the consumer product at the retailer and less the available inventory of the consumer product at a distributor.

18. The inventory planning system of claim 16, wherein the executable instructions to manipulate the at least one processor to determine an allocation of the consumer product among the distributors to prioritize fulfillment of the retailer inventory replenishment needs include executable instructions to manipulate the at least one processor to:
determine a first allocation of the consumer product to the distributors to fulfill the retailer inventory replenishment needs for the retailers; and
in response to the first allocation being less than a total supply of the consumer product available for distribution in the supply chain:
determine distributor inventory replenishment needs based on the distributor inventory data, each distributor inventory replenishment need indicating an additional stock of the consumer product needed at a corresponding distributor to meet a target inventory supply for the corresponding distributor; and
determine a second allocation of consumer product available after the first allocation based on the distributor inventory replenishment needs.

19. The inventory planning system of claim 18, wherein the target inventory of the consumer product for the retailer includes a target number of days of consumer product available at the retailer based on an estimated sales rate of the consumer product at the retailer.

20. The inventory planning system of claim 19, wherein the executable instructions to manipulate the at least one processor to determine an allocation of the consumer product among the distributors to prioritize fulfillment of the retailer inventory replenishment needs includes executable instructions to manipulate the at least one processor to:
in response to a sum of the retailer inventory replenishment needs exceeding an available supply of the consumer product, determine an allocation of the available supply of the consumer product that is proportional to at least one of the retailer inventory replenishment need of each retailer and the estimated sales rate of the stock at each retailer.
